(19) United States
(12) Patent Application Publication
(10) Pub. No.: US 2017/0193858 A1
(43) Pub. Date: Jul. 6, 2017

(54) HEMORRHAGE CONTROL TRAINER

(71) Applicant: Stuart C. Segall, La Jolla, CA (US)

(72) Inventor: Stuart C. Segall, La Jolla, CA (US)

(21) Appl. No.: 14/989,165

(22) Filed: Jan. 6, 2016

(51) Int. Cl. G09B 23/30

(52) U.S. Cl. CPC G09B 23/303

(57) ABSTRACT

A device for simulating wounds and injuries received during a trauma event includes a training suit worn over a manikin. A reservoir containing simulated blood is located between the back of the manikin and the training suit. Located on the training suit are various wound simulators such as leg, abdominal, arm, face, and neck wound simulators. The wound simulators are connected to a pumping and control system located inside the manikin, which controls the system such that pulse rates and blood loss are realistically simulated. The pumping and control system is wirelessly connected to an external control device, which allows a trainer to monitor and control the functions of the trainer. The ability to simulate a cricothyroidotomy, and other medical procedures related to airway management, is also provided.

### FIELD OF THE INVENTION

The present invention pertains generally to devices and methods for use in simulating the injurious effects of a traumatic event on a person. More particularly, the present invention pertains to devices and methods for simulating the wounds and injuries that a person may receive during such an event. The present invention is particularly, but not exclusively, useful as a training aid for providing realistic-looking medical effects to first responders, in a dynamic presentation, when practicing first aid on a person who has experienced trauma resulting in a hemorrhaging wound.

### BACKGROUND OF THE INVENTION

As is well known, and widely accepted, task simulators and training aids can be very effective for teaching individuals how to perform a wide variety of different tasks. More specifically, they can be extremely helpful for teaching an individual how to perform certain medical procedures. In this context, and of particular importance for the present invention, are those medical procedures that are required for response to a life-threatening, emergency situation resulting in hemorrhaging wounds. The import here is two-fold. Firstly, the partial task simulator should effectively augment the educational background that is necessary to assess an emergency situation. Secondly, it should serve as a tool with which a person can learn how to respond to an emergency situation by properly performing essential life-saving tasks. The efficacy of any task simulator or training aid, however, is dependent on the realism it provides and its ability to simulate or mimic an environment where the task is to be actually performed.

With the above in mind, a catastrophic event presents a situation wherein the proper training of emergency medical personnel can be invaluable. Regardless whether the event is the result of an accident, a natural disaster, or some form of combat, the consequence of a first response to the event may make the difference between life and death. In such instances, the ability of medical personnel to rapidly and reliably attend to wounds and injuries is of crucial importance. Practice on task simulators, such as medical mannequins, are valuable teaching aids. Further, one task simulator can be used to train several trainees at the same time by allowing one trainee to perform the actual medical procedures required by the simulation while the other trainees observe the response. In addition, the task simulator can be used to train trainees to assist a lead responder when performing the medical procedures. When the simulation comes to an end, the training device can be reset to allow the next person to perform the medical procedure, thereby increasing the training value of the simulation.

In light of the above, it is an object of the present invention to provide a device for realistically and dynamically simulating hemorrhaging wounds that can be received during a traumatic event. Another object of the present invention is to provide a device that effectively functions as a training aid to teach a person how to treat the wounds and injuries that can be received by a person during a traumatic event. Still another object of the present invention is to provide a training aid for teaching how to treat hemorrhaging wounds that is easy to use, is simple to manufacture, and is comparatively cost effective.

### SUMMARY OF THE INVENTION

In accordance with the present invention, a hemorrhage control trainer (HCT) is provided for simulating the wounds on a medical mannequin that could be received by a person during a trauma event. Specifically, the device includes a medical mannequin located inside a reusable training suit resembling human skin. Structurally, the training suit is made primarily of silicone and nylon fiber, and it is formed as a layer having an inner surface and an outer surface, with the outer surface having a color and a texture that is comparable to human skin. Integral to the training suit are simulated wounds located at various places on the training suit. Each simulated wound has a blood supply tube attached such that the wound can simulate different types of bleeding, such a venous and arterial bleeding. The preferred embodiment of the HCT has wound simulators located at the right femoral artery, the left lower abdomen, the left arm, and the left face and neck. Alternative embodiments of the HCT have wound simulators located at other positions, such as a foot, a hand, a calf, a forearm, the chest, and the back. Other alternative embodiments allow for the simulation of a traumatic amputation by allowing the removal of a portion of a leg or arm and the placement of a wound site simulator at the end of the remaining limb portion. The severed limb portion may have a skin covering that simulates the look and effect of a severed limb.

A head wound will interfere with airway management adding value to the training since airway management is crucial to stabilizing a wounded person. The trainee must learn to overcome the airway interference to become an effective first responder. Airway management is performed on an anatomically correct and architecturally detailed throat for surgical cricothyroidotomy with appropriate tissue layers and landmarks/index points. It also permits the proper use of basic airway adjuncts such as a nasopharyngeal airway (NPA) and oropharyngeal airway (OPA).

The mannequin is constructed from a rigid material that will resist cuts, abrasions, and punctures. In the chest area is a removable chest plate that allows access to the internal components housed in the chest cavity of the HCT. Located in the chest cavity are a pump, flow and pressure sensors, valves, tubing, a power supply, and a controller for controlling the internal components of the HCT. Located between the back of the mannequin and the training suit is a blood reservoir, which is in fluid communication with the pump. When the mannequin and blood reservoir are inserted into the training suit, the wound simulators and blood reservoir are connected to the pumping system by way of tubing. The pump and valves are then operated as necessary to simulate different types of bleeding from the simulated wound. The blood reservoir is refillable without the need to remove the reservoir from the HCT.

Pulse emitters are located at various points on the mannequin to simulate the pulse of a person who has suffered a traumatic injury and is hemorrhaging blood. The pulse emitters are located such that palpable Carotid (neck), Brachial (lower abdomen), and Radial (wrist) pulses are simulated, which are the prime pulse locations for determining the current physical condition of a person. Pulses are correlated to simulated blood pressure and have appropriate pulse deficit. The pulse emitters may have integrated sensors that send and receive signals with an external control unit.

In operation, an operator initiates bleeding and pulses through the external control unit. A trainee then assesses the wounds, bleeding, and pulses to prioritize the appropriate response actions. To control the bleeding, a trainee may apply a Combat Application Tourniquet (CAT), Combat Ready Clamp (CROC), or other junctional tourniquet, or may apply pressure to a wound with a pressure dressing, body weight, or packing such as Combat Gauze.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front view of a HCT in accordance with the present invention showing a mannequin wearing a training suit having simulated wounds, a trachea insertion area, and the locations of the pulse emitters;

FIG. 2 is a front view of the mannequin without the training suit, showing the pulse emitters, chest plate, battery compartment, and bleed connectors;

FIG. 3 is a front view of the blood reservoir with connector tube;

FIG. 4 is back view of the mannequin partially wearing the training suit showing how the blood reservoir is incorporated into the HCT;

FIG. 5 is a front view of a trachea insert;

FIG. 6 is a front view of a skin cover;

FIG. 7 is a view of the control screen on a remote control device allowing control of blood pressure, pulse rate, rate of blood loss, and system information; and

FIG. 8 is a diagram of the HCT system showing the interconnection of the valves, controllers, blood reservoir, wireless connection, and tubing.

### DETAILED DESCRIPTION

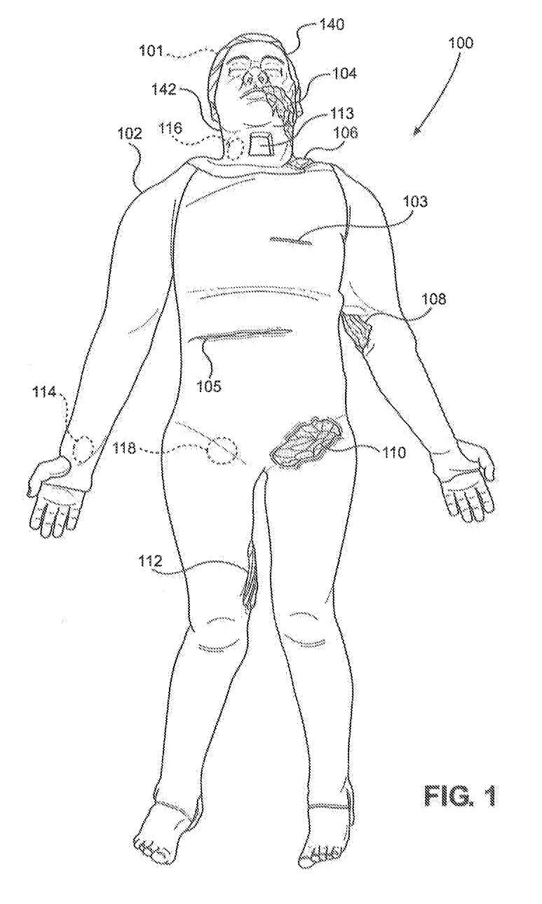

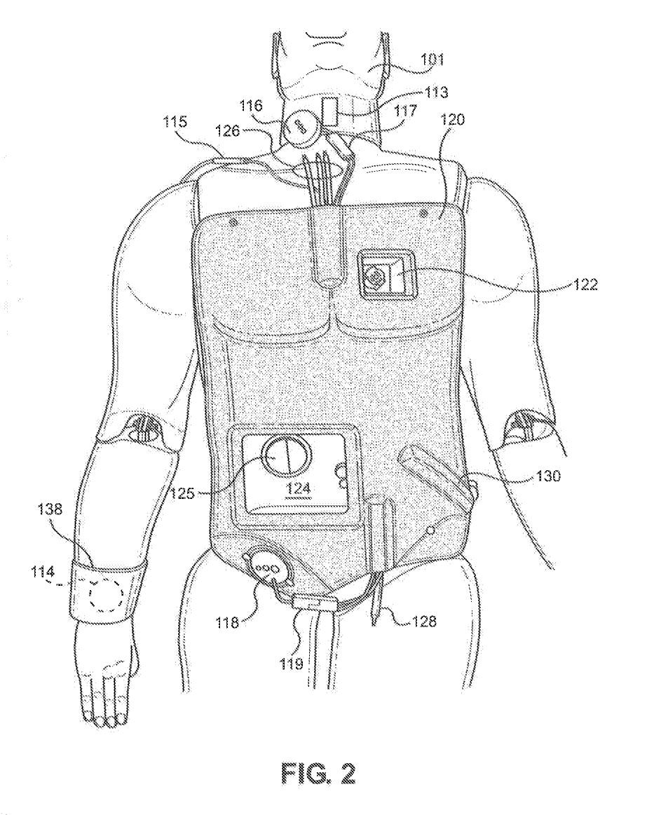

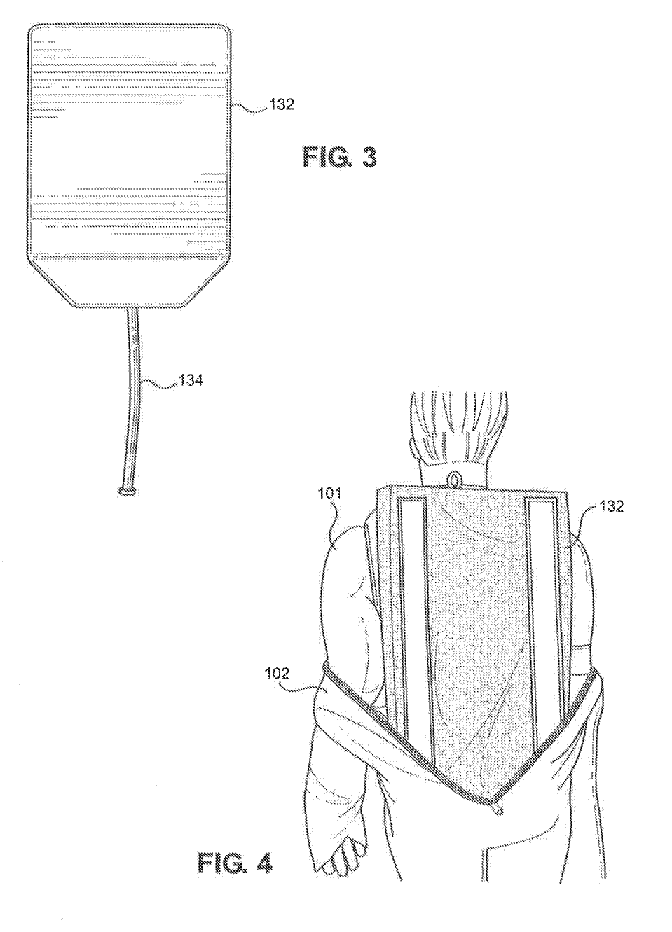

Referring initially to FIG. 1, a Hemorrhage Control Trainer (HCT) of the present invention is shown and designated 100. As shown, HCT 100 consists of a manikin 101, a training suit 102, and a blood bladder 132 (not shown, See FIGS. 3 and 4). In operation, manikin 101 is inserted into training suit 102. Bladder 132 is inserted between the back of manikin 101 and training suit 102. Training suit 102 further consists of a fill connector access 103, a facial wound simulator 104, a battery compartment access 105, a thorax wound simulator 106, an arm wound simulator 108, an abdominal wound simulator 110, a leg wound simulator 112, and a trachea module insertion area 113. Shown in phantom are a radial pulse emitter 114, a carotid pulse emitter 116, and a femoral pulse emitter 118. The operation of pulse emitters 114, 116, 118 will be discussed further in the discussion of FIG. 2. It is to be appreciated by someone skilled in the art that the number and type of wound simulators located on the training suit 102 may vary depending on the simulated trauma event.

Fill connector access 103 allows for quick access to fill connector 122 (not shown, see FIG. 2) when training suit is on manikin 101. Providing quick access to fill connector 122 allows for the refilling of bladder 132 without the need to of removing or partially removing training suit 102 from manikin 101. This allows HCT 100 to be quickly reset to a starting condition to allow for more efficient training of multiple trainees or faster repetition for a single trainee. As with fill connector access 103, battery compartment access 105 allows for quick access to battery compartment 124 to allow HCT 100 to also be quickly reset to a starting condition for more efficient training. Further, a training cycle may require the replacement of a battery 125 (see FIG. 2) during the training cycle, thereby creating the need to quickly replace the battery 125 to minimize the impact on the quality and length of the training cycle. In alternative embodiments of the HCT, two or more batteries may be used to extend the duration of the training cycle or to supply more power to the HCT.

Thorax wound simulator 106, arm wound simulator 108, abdominal wound simulator 110, and leg wound simulator 112 simulate wounds that each need different techniques to control bleeding from a real such wound. In a preferred embodiment, wound simulators 106, 108, 110 and 112 are individually configured to simulate different types of wounds, such as a wound resulting in arterial bleeding where the simulated blood may exit in pulses, or in venous bleeding where simulated blood may ooze, drip, or flow at a slower and more constant rate then with arterial bleeding. Non-bleeding wounds may also be simulated in conjunction with bleeding wounds to increase training realism. Wound simulators 106, 108, 110, and 112 may also be configured to simulate the look of a particular type of wound. For example, a puncture wound may be simulated as a hole in training suit 102 having simulated blood flowing from the hole, where an impact wound may result in an open wound covering a larger area. It is beneficial to the realism of the training to make these types of wounds look as real as possible. As such, wound simulators 106, 108, 110 and 112 in a preferred embodiment are constructed such that internal organs, veins, arteries, and skin layers are realistically simulated, including the source of bleeding from within the wound itself.

Thorax wound simulator 106 is located at the base of training suit head 140 and extends down the neck 142 of training suit 102. In operation, through a system discussed further below, the simulator 106 is connected to a pumping system that provides a flow of simulated blood to wound simulator 106. When the pumping system is activated, simulated blood is supplied to wound simulator 106 where it flows from the simulator 106 in the manner dictated by the training scenario. For instance, wound simulator 106 may simulate an arterial wound. As such, the simulated blood flow from wound simulator 106 will be in pulses and have a higher volume of flow from the wound simulator 106. In contrast, if a venous wound is simulated, blood flow from wound simulator 106 will be more consistent and may have a lower volume of flow.

Arm, abdominal, and leg wound simulators 108, 110, and 112 function similar to thorax wound simulator 106. The look of a wound simulator is determined by the type of wound simulated and the goals of the training session. The type of wound simulator selected for the training session partially determines the nature of the blood flow from the simulated wound. For example, a wound simulator may simulate a shallow laceration resulting in a slow blood flow where a puncture wound or deep laceration result in a high blood flow. As discussed below in regards to the pumping system, the operation of the pump system will also determine the nature of the blood flow from a simulated wound.

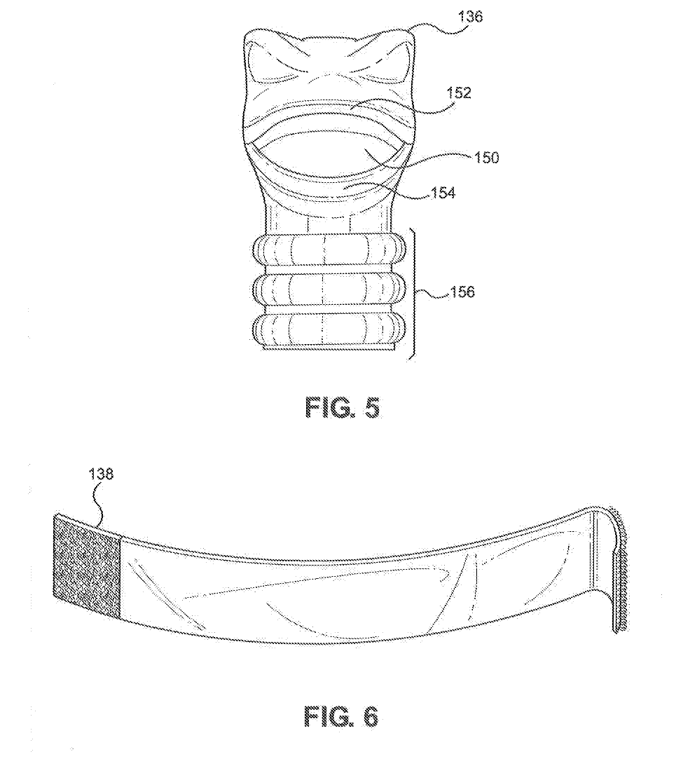

Referring now to FIG. 2, the construction of manikin 101 is shown. Manikin 101 consists of a chest plate 120 which covers the internal cavity of manikin 101. Located behind chest plate 120 is the blood pumping system (not shown). Fill connector 122 and battery compartment 124 are accessible through chest plate 120. Also shown in FIG. 2 are radial, carotid, and femoral pulse emitters 114, 116, and 118, and pulse emitter connectors 115, 117, and 119, bladder connector 130, and bleed connectors 126 and 128. Skin cover 138 is used to cover the wrist and neck of manikin 101 to increase the realism of the training by creating a more realistic palpable pulse. In a preferred embodiment, skin cover 138 also covers trachea module insertion area 113 where trachea module 136 (not shown, see FIG. 5). When skin cover 138 is in place, a trainee must locate the proper location on the trachea module 136 through skin cover 138 to perform a cricothyroidotomy, which is used to open an airway for breathing.

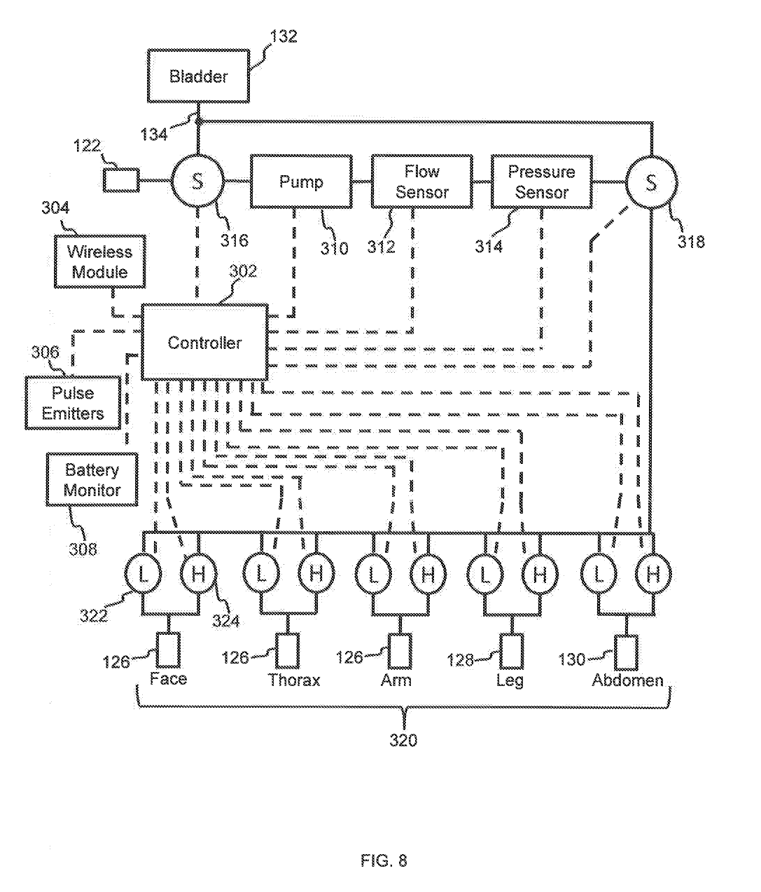

Pulse emitters 114, 116, and 118 emit mechanical pulses in response to signals from the central controller 300 (not shown, see FIG. 8). When a trainee places a finger on the outside of the training suit 102 over a pulse emitter 114, 116, and 118, the trainee can feel the rate and intensity of the pulses. The mechanical pulses are coordinated to simulate the pulse and heart rate of an injured person having the types of wounds simulated in the training session. Using this information, the trainee can make a determination of the condition of the injured person and prioritize the required actions to stabilize the injured person, such as breathing assistance or compression to minimize or stop bleeding. The rate and intensity of the pulses may be controlled by a preset program running on central controller 300 or may be adjusted in real time by a training supervisor using a remote control unit 200 in response to the actions of the trainee.

Referring now to FIG. 3, bladder 132 with connector tube 134 is shown. Bladder 132 is connected to bladder fill connector 130 by way of bladder connector tube 132. In a preferred embodiment, bladder fill connector 130 also serves as the abdominal bleed connector. In operation, bladder 132 is located inside training suit 102 between the back of manikin 101 and training suit 102 as shown in FIG. 4. When the HCT 100 is placed on its back during a simulation, the weight of the HCT 100 on bladder 132 provides a source of pressure for the pumping system. However, if the HCT 100 is oriented on its side, the pumping system is capable of providing full pressure to simulate all types of wounds. Central controller 300, as discussed further with FIG. 8, is capable of monitoring system pressure and blood flow rate and to adjust system parameters to maintain a realistic training simulation.

FIG. 5 shows a trachea module and is designated 136. Module 136 is inserted into trachea module insertion area 113 located at the throat area of manikin 101. Trachea module 136 simulates the physical construction of a human trachea, which includes the thyroid cartilage 152, the cricoid cartilage 154, and the tracheal rings 156. After trachea module 136 is inserted into trachea module insertion area 113, skin cover 138 is installed over the insertion area 113. In operation, a trainee must palpate the throat area to locate the trachea module 136, the thyroid cartilage 152, the cricoid cartilage 154, and the tracheal rings 156 to determine the proper location to cut through skin cover 138 to access the proper location on trachea module 136 to perform a cricothyroidotomy to assist with breathing.

FIG. 6 shows skin cover 138. To hold skin cover 138 in place, a fastening means such as hook and loop type fasteners are used. When skin cover 138 is placed over a pulse emitter (see FIG. 2), a trainee is able to palpate the area and find the emitted pulse.

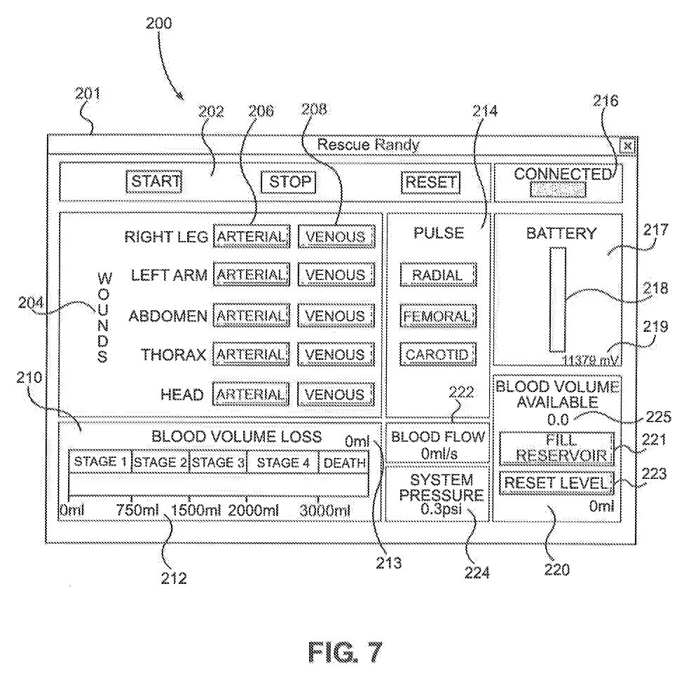

FIG. 7 is a diagram view of a control screen typical of a remote control device and is designated 200. Through control device 200, a trainer or operator may operate all functions of HCT 100 through GUI 201. Specifically, the trainer/operator may start, stop, and reset the simulator through section 202 of 201. Connection indicator 216 indicates a connection has been established between control device 200 and the HCT 100. Wound control 204 allows the trainer/operator to start and stop either arterial or venous like bleeding from a leg, arm, abdomen, thorax, or head wound. Blood loss indicator 210 indicates the total amount of blood lost by the HCT 100. To indicate the amount of blood loss, blood loss scale 212 indicates by way of a bar graph the amount of blood loss during the simulation. Blood loss is categorized in stages, specifically Stages 1 through 4. When blood loss reaches the end of Stage 4 (3000 milliliter total blood loss), death may be assumed. Blood loss indicator also shows blood loss total 213, which shows the calculated level of blood loss.

Section 214 of user interface 200 provides control for the Radial, Carotid, and Femoral pulse emitters 114, 116, and 118. In manual operation, the user may input a desired pulse rate. Depending on the type of wound being simulated, one pulse emitter may be set to a different rate from the other pulse emitters. For example, femoral pulse emitter 118 may be set to a slower pulse rate than radial and carotid pulse emitters 114 and 116. If the pulse rates are controlled by a pre-programmed sequence, an operator may override the pre-programmed settings with manual settings.

Connection indicator 216 of control device 200 provides an indication when control device 200 is connected to HCT 100. In a preferred embodiment, the connection between control device 200 and HCT 100 is wireless, which includes radio frequency and infrared. However, wired connections are fully contemplated and do not depart from the spirit of the invention.

Battery indicator 217 consists of battery charge indicator 218 and battery output voltage indicator 219. Battery charge indicator 218 is a bar graph indicator that shows the current charge level of battery 125. The output voltage of battery 125 is indicated by battery output voltage indicator 219. Depending on the type of battery 125 used to power HCT 100, battery output voltage indicator 219 can be used to determine the amount of battery life remaining in battery 125. For example, the output voltage of an alkaline battery drops linearly during use whereas a typical rechargeable battery has a small drop in output voltage during use until the end of the battery charge where the output voltage suddenly experiences a sharp drop.

Blood volume indicator 220 consists of a fill reservoir button 221, a reset level button 223, and an available blood volume indicator 225. In operation, the user presses fill reservoir button 221 to input the amount of blood added to bladder 132. After filling bladder 132, the operator presses reset level button 223 to set available blood volume indicator 225 back to zero (0). Lastly, control device 200 has a system pressure indicator 224, which indicates the current pressure in the pumping system.

Referring now to FIG. 8, an exemplary system diagram of HCT 100 is shown and designated 300. The electrical portion of system 300 consists of controller 302, which is responsible for coordinating the operation of system 300. Connected to controller 302 is wireless module 304, pulse emitters 306, battery monitor 308, pump 310, flow sensor 312, pressure sensor 314, solenoids 316 and 318, and output control valves 320.

The mechanical portion of System 300 consists of bladder 132, which is connected to solenoids 316 and 318. Solenoid 316 is connected to pump 310 and fill connector 122. The output of pump 310 goes to flow sensor 312 and pressure sensor 314. The output of pressure sensor 314 is connected to solenoid 318, which in turn connects to control valves 320. Control valves 320 connect to the various wound locations on training suit 102. For example, low pressure control valve 322 and high pressure control valve 324 both connect to facial wound simulator 104 (not shown).

In operation, controller 302 controls the operation of the internal components of system 300. Solenoids 316 and 318 control the flow to and from bladder 132. For example, when filling bladder 132, a volume of simulated blood is connected to fill connector 122. Controller 302 adjusts solenoid 316 such that the simulated blood is directed from fill connector 122 to bladder 132. After bladder 132 is filled to the desired level, controller 302 adjusts solenoid 316 to isolate fill connector 122 from bladder 132 and pump 310. When a user initiates a training sequence or manually inputs a pump command from remote control device 200, solenoid 316 adjusts such that bladder 316 is connected to the input of pump 310. Pump 310 is controlled by controller 302 to simulate the desired wound conditions. For example, pump 310 can be pulsed to help simulate the flow of blood in an arterial wound. Pump 310 can also be run at a constant pressure when control valves 320 are used to control the blood flow from a wound.

The output of pump 310 is connected to flow sensor 312 and pressure sensor 314, which send flow and pressure data to controller 302 to be used, for example, to calculate blood loss during a simulation. As a further example, in some training scenarios, HCT 100 is positioned on its back. This causes the weight of manikin 101 to apply a downward force on bladder 132 thereby creating a pressure inside bladder 132. This pressure is then used to force the flow of blood to control valves 320 through solenoid 318 where control valves 320 are used to simulate the type of blood flow required for the type of simulated wound. In this configuration, pump 310 is not used.

In a typical operation, the output from pressure sensor 314 is directed to solenoid 318, which then directs simulated blood flow to control valves 320. As described above, control valves 320 are connected to the wound simulators located on training suit 102 through bleed connectors. For example, the output of low and high pressure control valves 322 and 324 are connected to facial bleed connector 126, which in turn connects to facial wound simulator 104. The remaining control valves 320 are connected to thorax, arm, abdominal, and leg wound simulators 106, 108, 110, and 112 through neck and radial bleed connectors 126, femoral bleed connector 128, and abdominal bleed connector 130 respectively.

Wireless module 304 sends and receives data from control device 200. The use of a wireless connection allows for a user to remotely operate HCT 100 without the need for wires thereby adding to the realism of a simulation. Pulse emitters 306 are controlled by controller 302. In operation, controller 302 coordinates the pulse rates with the amount of blood loss. For example, a normal and strong pulse rate is simulated at the beginning of a training simulation. As the simulation progresses and the simulated blood loss increases, the simulated pulse rate may become quicker and faint until the amount of simulated blood loss would indicate impending death, where the pulse rate becomes almost unascertainable when the trainee palpates the area. When the volume of blood is lost through the simulated wound(s), death is indicated and the pulse ceases to exist.

Battery monitor 308 monitors the power supplied to the system. Battery monitor 308 inputs the output voltage of the battery 125, where controller 302 calculates the amount of remaining power and then sends that information to control device 200 through wireless module 304.

The main purpose of HCT 100 is to provide a simulation of an injured person suffering from one or more wounds. They type of wound(s) simulated determines the type of response necessary to save the life of a real person suffering from such injuries. For example, an arterial leg wound may require the use of a CAT to control the bleeding. If a trainee fails to timely assess HCT 100 and apply a CAT to the leg wound, then blood loss with continue and the femoral pulse emitter 118 will indicate the appropriate pulse deficit. As blood loss continues, the pulse deficit will increase even further until the trainee takes the proper remedial measures or the system indicates the injured person is dead, where all pulses will stop. As another example, a facial wound may require the use of a pressure dressing or packing (e.g. combat gauze) to control bleeding. The simulation may also require the use of a CROC, other types of tourniquets, and even the body weight of a trainee to control blood loss. Typical bandaging techniques may also be used to control bleeding.

In the event a facial or neck wound is simulated, an airway management capability is provided. Trachea module 136 (see FIG. 5) is inserted into trachea module insertion area 113 (See FIGS. 1 and 2) of manikin 101, which is then covered with skin cover 138. In operation, a trainee palpates trachea module 136 for index points to find the proper location for a cricothyroidotomy. After locating the proper index points, the trainee cuts through skin cover 138 then trachea module 136, followed by insertion of an airway adjunct. Thus, the trachea module 136 can be used for simulating an invasive surgical placement of a cricothyroidotomy. The use of an NPA and OPA may also be dictated by the simulation.

It is to be appreciated by someone skilled in the art that the various features of one or more embodiments may be combined with various features of one or more other embodiments without departing from the scope of the invention.

While the particular Hyper-realistic Hemorrage Control Trainer as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A hemorrhage control trainer, comprising:
a training suit comprising one or more wound simulators;
a manikin configured to fit inside the training suit;
a blood bladder configured to fit inside the training suit between the training suit and the manikin;
a system to move simulated blood from the bladder to the one or more wound simulators; and
a controller configured to operate the hemorrhage control trainer.

2. The hemorrhage control trainer of claim 1, wherein the one or more wound simulators comprise:
a facial wound simulator;
a thorax wound simulator;
an arm wound simulator;
an abdominal wound simulator; and
a leg wound simulator.

3. The hemorrhage control trainer of claim 1, wherein the various wound simulators may simulate bleeding and non-bleeding wounds.

4. The hemorrhage control trainer of claim 1, wherein the one or more wound simulators are configured to simulate a puncture wound or an impact wound.

5. The hemorrhage control trainer of claim 1, wherein the one or more wound simulators are constructed to simulate internal organs, veins, arteries, skin layer, and a source of bleeding from within the one or more wound simulators.

6. The hemorrhage control trainer of claim 1, wherein the training suit further comprises a trachea module insertion area configured to receive a removable trachea module.

7. The hemorrhage control trainer of claim 6 further comprising a cover configured to cover the trachea module insertion area.

8. The hemorrhage control trainer of claim 6, wherein the cover is configured to simulate human skin.

9. The hemorrhage control trainer of claim 6, wherein the removable trachea module further comprises simulated thyroid cartilage, cricoid cartilage, and tracheal rings configured to allow a trainee to palpate the trachea module insertion area to locate the proper position to perform a procedure that assists with breathing.

10. The hemorrhage control trainer of claim 1, wherein the training suit further comprises:
a fill connector access; and
a battery compartment access.

11. The hemorrhage control trainer of claim 1, wherein the manikin further comprises:
an internal cavity adapted to house the system to move simulated blood;
a fill connector;
one or more wound simulator connectors to connect the one or more wound simulators to the system to move simulated blood;
a battery compartment configured to receive at least one removable battery unit;

12. The hemorrhage control trainer of claim 1, the manikin further comprising one or more pulse emitters configured to emit mechanical pulses in response to signals from the controller.

13. The hemorrhage control trainer of claim 12, wherein the mechanical pulses are coordinated to simulate the pulse and heart rate of an injured person having the types of wounds simulated by the hemorrhage control trainer.

14. The hemorrhage control trainer of claim 12, the manikin further comprising a radial pulse emitter, a carotid pulse emitter, and a femoral pulse emitter.

15. The hemorrhage control trainer of claim 1, wherein the system to move simulated blood comprises:
a pump in communication with the controller and configured to provide a flow of simulated blood to the one or more wound simulators;
a high pressure valve and a low pressure valve for each wound simulator, the valves in communication with the controller;
a wireless module configured to communicate with a remote control device

16. The hemorrhage control trainer of claim 15, wherein the system to move simulated blood is configured to simulate an arterial wound or a venous wound, wherein the arterial wound simulator discharges pulses of simulated blood with a higher volume of simulated blood flow, and wherein the venous wound simulator discharges a more constant flow of simulated blood with a lower volume of simulated blood as compared to the arterial wound simulator.

17. The hemorrhage control trainer of claim 1, wherein the hemorrhage control trainer is further configured to allow the application of a tourniquet to control the flow of simulated blood from the one or more wound simulators.

18. The hemorrhage control trainer of claim 1 further comprising a remote control device configured to control the functions of the hemorrhage control trainer.

19. The hemorrhage control trainer of claim 18 wherein the remote control device is further configured to allow manual control of the hemorrhage control trainer's functions.

20. The hemorrhage control trainer of claim 18 wherein the remote control device is further configured to allow automatic control of the hemorrhage control trainer's functions, wherein the remote control device uses input from sensors located in the hemorrhage control trainer to determine the required settings of the trainer's functions.
